(19) United States
(12) Patent Application Publication
(10) Pub. No.: US 2004/0124987 A1
(43) Pub. Date: Jul. 1, 2004

(54) Fluid level monitor for tree stands

(76) Inventor: Kenneth E. Moretz, Hickory, NC (US)

Correspondence Address: SCHWARTZ LAW FIRM, P.C., 6100 FAIRVIEW ROAD, SUITE 530, CHARLOTTE, NC, 28210, US

(21) Appl. No.: 10/335,339

(22) Filed: Dec. 31, 2002

(51) Int. Cl. G08B 21/00

(52) U.S. Cl. 340/604

(57) ABSTRACT

A fluid level monitor is provided for use in a tree stand. The tree stand defines a fluid-containing well for receiving a cut end of a tree. The monitor includes a body, and an indicator located on the body. A fluid sensor is operatively connected to the indicator, and is adapted for communicating with the well of the tree stand. When the fluid contained in the well reaches a predetermined minimum level, the fluid sensor causes the indicator to emit an alarm indicating a low level fluid condition in the well.

### TECHNICAL FIELD AND BACKGROUND OF INVENTION

This application relates to a fluid level monitor for tree stands, such as those used for holding natural Christmas trees. Christmas trees are displayed in most homes for three to four weeks during the holiday season. To prolong the freshness of the tree, salesmen recommend sawing off at least one inch of the trunk, and then mounting the tree in a stand that holds water. The water level in the stand should be maintained above the cut at all times. This keeps the tree fresh and green, and reduces the risk of fire. The present invention serves to clearly indicate a low level fluid condition in the stand, and offers convenient means for refilling the stand when necessary.

Natural Christmas trees are located in more than 33 million American homes. While festive and traditional, these trees account for 400 fires annually, resulting in 10 deaths, 80 injuries and more than $15 million in property damage. Typically, shorts in electrical lights or open flames from candles, lighters or matches start tree fires. Well-watered trees are not a problem. Dry and neglected trees can be.

When fire touches a dry Christmas tree, within three seconds of ignition the tree is completely ablaze. At five seconds, the fire extends up the tree and black smoke with searing gases streaks across the ceiling. Fresh air near the floor feeds the fire. Surrounding furniture and carpeting ignite prior to any flame contact. Within 40 seconds “flashover” occurs—that's when an entire room erupts into flames, oxygen is depleted and dense, and deadly toxic smoke engulfs the scene.

Wet trees tell a different story. For comparative purposes, the NIST fire safety engineers selected a green Scotch pine, had it cut in their presence, had an additional two inches cut from the trunk's bottom, and placed the tree in a stand with at least a 7.6 liter water capacity. The researchers maintained the Scotch pine's water on a daily basis. A single match could not ignite the tree. A second attempt in which an electric current ignited an entire matchbook failed to fire the tree. Finally, an open flame was applied to the tree using a propane torch. The branches ignited briefly, but self-extinguished when the researchers removed the torch from the branches. The present invention reduces the risk of fire by promoting and encouraging proper tree wetness during the holiday season.

### SUMMARY OF INVENTION

Therefore, it is an object of the invention to provide fluid level monitor for a tree stand adapted for holding a Christmas tree.

It is another object of the invention to promote and encourage proper Christmas tree wetness.

It is another object of the invention to reduce the risk of fire caused by dry Christmas trees.

It is another object of the invention to provide clear means for indicating a low level fluid condition in a tree stand.

It is another object of the invention to provide convenience means for refilling the tree stand.

It is another object of the invention to provide a fluid level monitor which includes a decorative ornament adapted for being hung from a tree mounted in the stand.

It is another object of the invention to provide a fluid fill device for filling a tree stand and which includes a decorative ornament adapted for being hung from a tree mounted in the stand.

It is another object of the invention to provide a method for maintaining proper fluid level in a tree stand.

These and other objects of the present invention are achieved in the preferred embodiments disclosed below by providing a fluid level monitor for use with a tree stand. The tree stand defines a fluid-containing well for receiving a cut end of a tree. The monitor includes a body, and an indicator located on the body. A fluid sensor is operatively connected to the indicator, and is adapted for communicating with the well of the tree stand. When the fluid contained in the well reaches a predetermined minimum level, the fluid sensor causes the indicator to emit an alarm indicating a low level fluid condition in the well.

Preferably, the body is a decorative ornament.

Preferably, the ornament includes a tree hanger adapted for suspending the ornament from the tree.

According to another preferred embodiment of the invention, the indicator includes a light located on the body.

According to another preferred embodiment of the invention, the indicator includes a series of lights located on the body. The lights are adapted for indicating different levels of fluid contained in the well.

According to another preferred embodiment of the invention, the fluid sensor includes an electric contact adapted for being closed when the fluid in the well reaches the predetermined minimum level, thereby providing an operative current flow to the indicator.

According to another preferred embodiment of the invention, a hollow vertical column is formed adjacent to the well of the tree stand. The vertical column has an inlet which communicates with the well such that the fluid level in the vertical column corresponds to the fluid level in the well.

According to another preferred embodiment of the invention, the fluid sensor includes a float assembly located in the vertical column. The float assembly cooperates with the indicator to indicate a level of fluid contained in the well.

In another embodiment, the invention is a method for maintaining proper fluid level in a tree stand. The tree stand defines a fluid-containing well adapted for receiving a cut end of a tree. The method includes the steps of attaching a body of a fluid level monitor to the tree. A fluid sensor of the fluid level monitor communicates with the well of the tree stand. When fluid contained in the well reaches a predetermined minimum level, the fluid sensor causes an indicator located on the body to emit an alarm indicating a low level fluid condition in the well.

According to another preferred embodiment of the invention, the step of attaching the body of the fluid level monitor to the tree includes suspending the body from the tree by a tree hanger.

According to another preferred embodiment of the invention, the method includes attaching a funnel of a fluid fill device to the tree. The fill device including an elongated hollow tube extending from the funnel to the well of the tree stand. The well of the tree stand is filled by pouring fluid into the funnel and through the hollow tube.

Preferably, the funnel of the fill device is a decorative ornament.

### BRIEF DESCRIPTION OF THE DRAWINGS

Some of the objects of the invention have been set forth above. Other objects and advantages of the invention will appear as the description proceeds when taken in conjunction with the following drawings, in which:

FIG. 1 is a perspective view of a tree stand incorporating a fluid level monitor and fluid fill device according to respective preferred embodiments of the present invention;

FIG. 2 is an enlarged perspective view showing components of the fluid level monitor and fluid fill device located in the tree stand, and showing a cylindrical wall of the tree stand in phantom;

FIG. 3 is a view of the fluid level monitor according to a second preferred embodiment of the present invention;

FIG. 4 is a view of the fluid level monitor according to a third preferred embodiment of the present invention;

FIG. 5 is a sectional view of the cylindrical wall of the tree stand, and showing the location of the sensor probes communicating With the water well; and

FIG. 6 is a circuit schematic illustrating operation of the fluid level monitor.

### DESCRIPTION OF THE PREFERRED EMBODIMENT ANFD BEST MODE

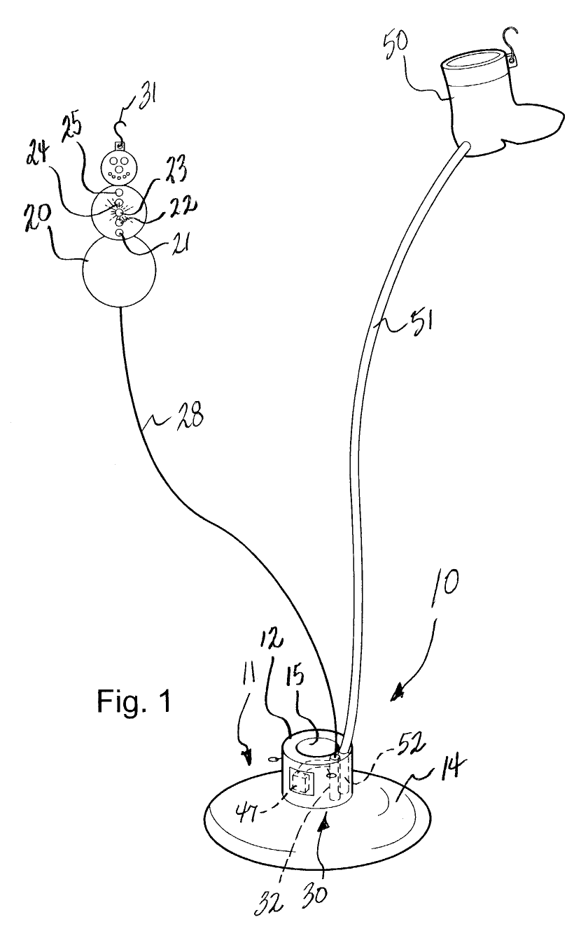

Referring now specifically to the drawings, a fluid level monitor according to the present invention is illustrated in FIG. 1, and shown generally at reference numeral 10. The monitor 10 is used in a tree stand 11 comprising an integrally-formed cylindrical wall 12 and enlarged base 14. The cylindrical wall 12 defines a water well 15 adapted for receiving the cut end of a tree, such as a Christmas tree. The monitor 10 serves to indicate proper fluid level in the well 15 of the stand 11. The tree stand 11 is preferably custom designed, as described below, to receive components of the fluid level monitor 10. In an alternative application, any standard commercial tree stand may be retrofit to incorporate the fluid level monitor 10 of the present invention.

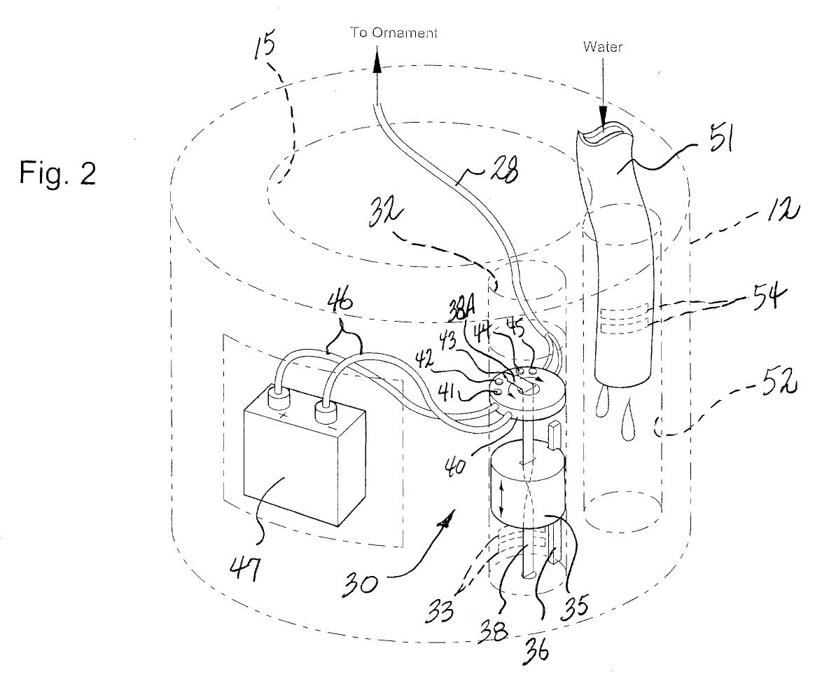

Referring to FIGS. 1 and 2, the fluid level monitor 10 includes a lightweight, decorative tree ornament 20 with a series of LED indicator lights 21, 22, 23, 24, and 25 electrically connected through a wire 28 to a fluid sensor 30. The ornament 20 is preferably suspended from the tree using a metal hook 31 or other suitable tree hanger. The fluid sensor 30 is located inside the cylindrical wall 12 of the tree stand 11 and within a vertical column 32 which communicates with the water well 15 through openings 33. The fluid sensor 30 includes a buoyant float 35 which rides along a stationary post 36, and defines a center slot 37 for receiving a rotatable twisted metal shaft 38. The twisted shaft 38 extends through a fixed contact dial 40, and is bent 90 degrees at its free end 38A to operatively engage one of a series of electric contacts 41, 42, 43, 44, and 45. The electric contacts 41-45 correspond to the LED's 21-25 located on the decorative tree ornament 20. The contact dial 40 is electrically connected through wires 46 to a battery 47 which supplies energy to the LED's 21-25 when the twisted shaft 38 engages a contact 41-45.

After the Christmas tree is cut and mounted in the stand 11, a sufficient amount of water is poured into the well 15 in order to locate the water level above the cut. Water flows from the well 15 and into the vertical column 32 through openings 33. The water level in the column 32 corresponds to that in the well 15, and causes the buoyant float 35 to rise upwardly along the stationary post 36. As the float 35 moves up, the twisted shaft 38 rotates in a clockwise direction and settles on one of the electric contacts 43 located on the contact dial 40, as shown in FIG. 2. The closed contact 43 permits current flow from the battery 47 through the wire 28 to the LED 23 on the tree ornament 20, as shown in FIG. 1. Activation of LED 25 indicates a high level of water contained in the well 15, whereas LED 21 indicates a low level condition. Preferably, if the water level in the well 15 drops below a point needed to activate LED 21, an audible or visual alarm is emitted from the ornament 20. In an alternative embodiment, the fluid level monitor 10 may include an RF transmitter and receiver or other wireless technology operable for transmitting the water level condition in the well 15 from the sensor 30 to the tree ornament 20.

In a low-level water condition, the tree stand 11 may be conveniently refilled using a fill ornament 50 hung from the Christmas tree by a suitable hanger. The fill ornament 50 defines a funnel connected to an elongated flexible tube 51 extending to a fill column 52 formed in the cylindrical wall 12 of the tree stand 11. The fill column 52 communicates with the water well 15 through openings 54. Water poured into the fill ornament 50 passes through the flexible tube 51 into the fill column 52 of the tree stand 11 and outwardly through the openings 54 to the water well 15.

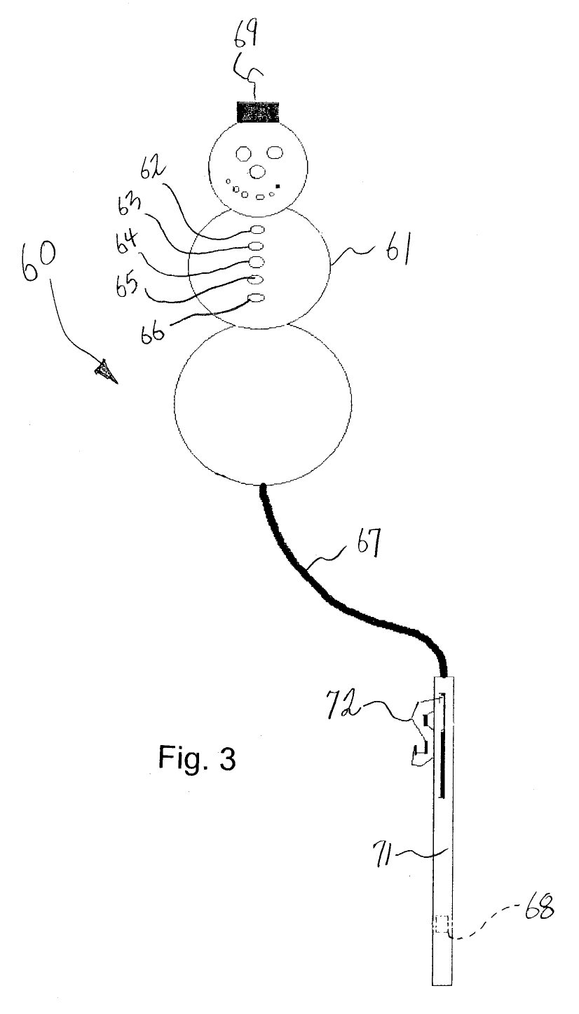

A second embodiment of a fluid level monitor 60 according to the present invention is shown in FIG. 3. The monitor 60 is applicable for use in any commercial tree stand. The monitor includes a lightweight, decorative tree ornament 61 with a series of LED indicator lights 62, 63, 64, 65, and 66 electrically connected through a wire 67 to a fluid sensor 68. The ornament 61 is preferably suspended from the tree using a metal hook 69 or other suitable tree hanger. The fluid sensor 68 is located inside an elongated hollow probe 71 adapted for ending within the water well of the tree stand. When the water level reaches a predetermined minimum level below the sensor 68, electric contacts close causing the indicator lights 62-66 to flash. An audible alarm (not shown) may also be incorporated inside the ornament 61. An adjustable clip 72 is provided for adjustably mounting the probe 71 to the tree stand inside the water well.

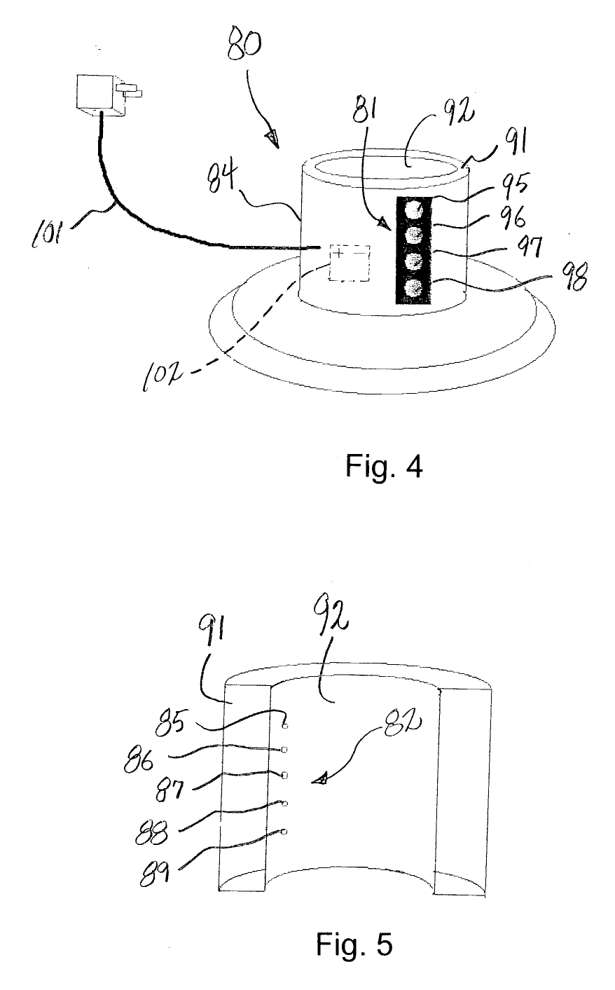

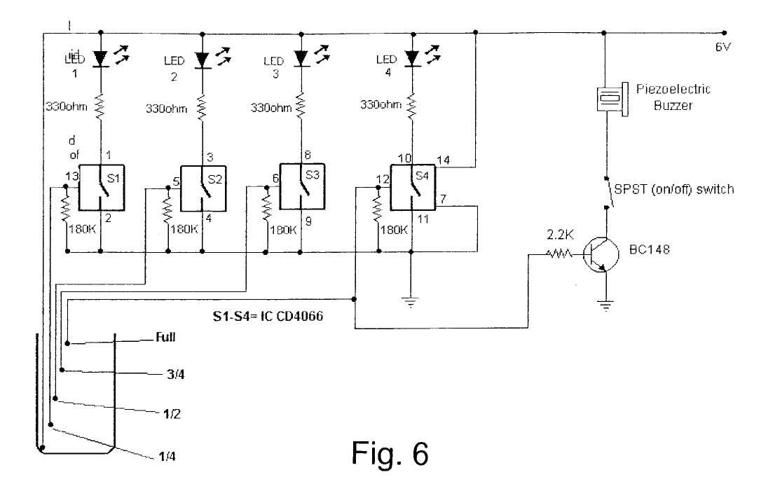

A third embodiment of a fluid level monitor 80 according to the present invention is shown in FIG. 4. In this embodiment, both the indicator 81 and sensor 82 are incorporated in the tree stand 84. The sensor 82 includes a series of probes 85, 86, 87, 88, and 89 located at varying elevations inside the cylindrical wall 91 and communicating with the water well 92, as shown in FIG. 5. The indicator 84 includes LED lights 95, 96, 97, and 98 which correspond to each of the sensor probes 85, 86, 97, and 88. When the water well 92 is full, sensor probe 85 closes a contact causing the indicator light 95 to activate. At 75% capacity, sensor probe 86 closes a contact causing the indicator light 96 to activate. At 50% capacity, sensor probe 87 closes a contact causing the indicator light 97 to activate. At 25% capacity, sensor probe 88 closes a contact causing the indicator light 98 to activate. When the well is almost dry, sensor probe 89 closes a contact causing an audible alarm to sound indicating a dangerous low-level fluid condition. A circuit schematic illustrating operation of the monitor 80 is provided in FIG. 6. Preferably, the monitor 80 is powered using a plug-in AC/DC converter 101 with a battery backup 102 located inside the tree stand 84.

A fluid level monitor and fill ornament are described above. Various details of the invention may be changed without departing from its scope. Furthermore, the foregoing description of the preferred embodiment of the invention and best mode for practicing the invention are provided for the purpose of illustration only and not for the purpose of limitation-the invention being defined by the claims.

I claim:

1. A fluid level monitor for use with a tree stand, the tree stand defining a fluid-containing well for receiving a cut end of a tree, said monitor comprising:
(a) a body;
(b) an indicator located on said body; and
(c) a fluid sensor operatively connected to said indicator and adapted for communicating with the well of the tree stand, such that when the fluid contained in the well reaches a predetermined minimum level, said fluid sensor causes said indicator to emit an alarm indicating a low level fluid condition in the well.

2. A fluid level monitor according to claim 1, wherein said body comprises a decorative ornament.

3. A fluid level monitor according to claim 2, wherein said ornament comprises a tree hanger adapted for suspending said ornament from the tree.

4. A fluid level monitor according to claim 1, wherein said indicator comprises a light located on said body.

5. A fluid level monitor according to claim 1, wherein said indicator comprises a series of lights located on said body, and adapted for indicating different levels of fluid contained in the well.

6. A fluid level monitor according to claim 1, wherein said fluid sensor comprises an electric contact adapted for being closed when the fluid in the well reaches the predetermined minimum level, thereby providing an operative current flow to said indicator.

7. In combination with a tree stand defining a fluid-containing well adapted for receiving a cut end of a tree, a fluid level monitor comprising:
(a) a body;
(b) an indicator located on said body; and
(c) a fluid sensor operatively connected to said indicator and communicating with the well of said tree stand, such that when the fluid contained in said well reaches a predetermined minimum level, said fluid sensor causes said indicator to emit an alarm indicating a low level fluid condition in said well.

8. A combination according to claim 7, wherein said body comprises a decorative ornament.

9. A combination according to claim 8, wherein said ornament comprises a tree hanger adapted for suspending said ornament from the tree.

10. A combination according to claim 7, wherein said indicator comprises a light located on said body.

11. A combination according to claim 7, wherein said indicator comprises a series of lights located on said body, and adapted for indicating different levels of fluid contained in said well.

12. A combination according to claim 7, wherein said fluid sensor comprises an electric contact adapted for being closed when the fluid in said well reaches the predetermined minimum level, thereby providing an operative current flow to said indicator.

13. A combination according to claim 7, wherein said tree stand comprises a hollow vertical column formed adjacent to said well, and having an inlet communicating with said well such that the fluid level in said vertical column corresponds to the fluid level in said well.

14. A combination according to claim 13, wherein said fluid sensor comprises a float assembly located in said vertical column and cooperating with said indicator to indicate a level of fluid contained in said well.

15. A method for maintaining proper fluid level in a tree stand, the tree stand defining a fluid-containing well adapted for receiving a cut end of a tree, said method comprising the steps of:
(a) attaching a body of a fluid level monitor to the tree; and
(b) locating a fluid sensor of the fluid level monitor in communication with the well of the tree stand, such that when fluid contained in the well reaches a predetermined minimum level, the fluid sensor causes an indicator located on the body to emit an alarm indicating a low level fluid condition in the well.

16. A method according to claim 15, wherein the step of attaching the body of the fluid level monitor to the tree comprises suspending the body from the tree by a tree hanger.

17. A method according to claim 15, and comprising attaching a funnel of a fluid fill device to the tree, the fill device comprising an elongated hollow tube extending from the funnel to the well of the tree stand, whereby the well of the tree stand is filled by pouring fluid into the funnel and through the hollow tube.

18. A method according to claim 17, wherein the funnel of the fill device comprises a decorative ornament.
